(19) United States
(12) Patent Application Publication
(10) Pub. No.: US 2010/0313214 A1
(43) Pub. Date: Dec. 9, 2010

(54) DISPLAY SYSTEM, SYSTEM FOR MEASURING DISPLAY EFFECT, DISPLAY METHOD, METHOD FOR MEASURING DISPLAY EFFECT, AND RECORDING MEDIUM

(76) Inventors: Atsushi Moriya, Tokyo (JP); Satoshi Imaizumi, Tokyo (JP)

Correspondence Address: Mr. Jackson Chen, 6535 N. STATE HWY 161, IRVING, TX, 75039, US

(21) Appl. No.: 12/864,779

(22) PCT Filed: Jan. 28, 2009
(86) PCT No.: PCT/JP2009/051363

§ 371 Date: Aug. 23, 2010

(30) Foreign Application Priority Data
Jan. 28, 2008 (JP) 2008-016938

(51) Int. Cl. H04H 60/33

(52) U.S. Cl. 725/12

(57) ABSTRACT

A display system (100) comprises a display device (11), a camera (21) for acquiring an image of an area in which display images on the display device (11) can be observed, and an effect measurement device (41) for analyzing images acquired by the camera (21), discriminating observers and determining distance from the display device (11) and the time spent paying attention to display images on the display device (11) for each discriminated observer. The effect measurement device (41) finds attributes for each observer and an index indicating the degree of attention paid to the display on the display device (11) in accordance with predetermined standards on the basis of the determined time spent paying attention and distance. This index value becomes larger as the time spent paying attention to the display image becomes larger, and becomes smaller as the distance becomes larger.

### TECHNICAL FIELD

The present invention relates to a display system equipped with a function for determining the impression display images have on observers, a display effect measurement system, a display method, a display effect measurement method and a recording medium.

### BACKGROUND ART

A system has been proposed (see Patent Literature 1) for measuring the effect of advertisements by displaying advertisements on a display device and measuring the degree to which there are people who see (observe) those advertisements.

Patent Literature 1: Japanese Unexamined Patent Application KOKAI Publication No. 2002-269290

### DISCLOSURE OF INVENTION

### Problems Solved by the Invention

The advertisement effect measurement system disclosed in Patent Literature 1 is nothing more than acquiring an image near the advertisement display device, analyzing the image acquired, and measuring the number of people in the acquired image or the movement status of various people. Accordingly, the advertisement effect evaluation system disclosed in Patent Literature 1 cannot appropriately evaluate the effects of advertisements.

For example, with the advertisement effect measurement system disclosed in Patent Literature 1, even if the gaze of a person in the acquired image is detected, no advertisement effect can be anticipated if that person if in a position far from the display device. In addition, with the advertisement effect measurement system disclosed in Patent Literature 1, even if the gaze of a person in the acquired image is detected, no advertisement effect can be anticipated if that person looks at the display for only an instant. Such analysis is not possible with Patent Literature 1.

In consideration of the foregoing, it is an objective of the present invention to provide a display system equipped with a function for accurately measuring the effect display images have on observers, a display effect measurement system, a display method, a display effect measurement method and a recording medium.

### Problem Resolution Means

In order to achieve the above objective, the display system relating to a first aspect of the present invention has:
a display device for displaying images;
an imaging means for acquiring images of a region where display images on the display device can be observed; and
an image analysis means for analyzing images acquired by the imaging means, discriminating observers who are looking at the display images on the display device, and assessing the time the discriminated observers observe the display images on the display device and their distance from the display device.

In addition, in order to achieve the above objective, the display effect measurement system according to a second aspect of the present invention has:
a discrimination means for analyzing images taken around a display device and discriminating people who are observing the display images; and
an image analysis means for assessing the time observers discriminated by the discrimination means spend observing the display images on the display device.

In addition, in order to achieve the above objective, the display method according to a third aspect of the present invention:
displays display images;
acquires images in a region where display images are visible; and
analyzes the acquired images and determines the time people observing the display images spend observing said display images and their distance from the display images.

In addition, in order to achieve the above objective, the display effect measurement method according to a fourth aspect of the present invention:
analyzes images taken in regions where display images are visible, and specifies people who are observing the display images; and
determines the time the specified people spend observing the display images and their distance from the display images.

In addition, in order to achieve the above objective, the recording medium according to a fifth aspect of the present invention is a recording medium readable by computer on which is recorded a program for causing a computer to function as:
an discrimination means for analyzing images of a region where display images on the display device can be observed and discriminating observers looking at said display images; and
an image analysis means for determining the time the observers discriminated by the discrimination means spend observing the display images of the display device and their distance from the display device.

### EFFECTS OF INVENTION

With the above composition, it is possible to accurately evaluate the effect a display has on observers because the time these observers spend looking at display images on the display device and the observers' distance from the display device are found.

### BRIEF DESCRIPTION OF DRAWINGS

FIG. 1 is a block diagram of an advertisement display system according to an embodiment of the present invention.

FIG. 2A is a side view and FIG. 2B is a planar view of the display device.

FIG. 3 is a block diagram of the advertisement distribution device shown in FIG. 1.

FIG. 4 is a drawing showing on example of a distribution schedule housed in a schedule DB.

FIG. 5 is a drawing showing the relationship between distance from the display device, stopping time and advertisement effect.

FIG. 6 is a block diagram of the effect measurement device shown in FIG. 1.

FIG. 7 is a drawing showing an example of information defining the relationship between feature value and attributes stored in a model DB.

FIG. 8 is a drawing showing one example of measurement results by advertisement observer stored in an advertisement effect memory.

FIG. 9 is a flowchart of the advertisement effect measurement process executed by the effect measurement device.

FIGS. 10A to 10D are drawings for explaining the correlation between temporary ID and fixed ID.

FIG. 11 is a drawing showing an example of temporary ID, face size and position and feature values correlated and stored in memory.

FIG. 12 is a drawing showing an example of a record formed in correlation to fixed ID.

FIGS. 13A and 13B are drawings showing the change in records accompanying the passage of time.

FIG. 14 is a flowchart showing the operation of erasing frame images after extracting feature values.

FIGS. 15A to 15D are drawings showing an example of the effect analysis method.

FIG. 16 is a drawing showing the composition of adding target attributes to content being distributed.

FIG. 17 is a drawing explaining the difference in advertisement effects based on the advertisement observers' movement direction.

FIG. 18 is a flowchart for finding advertisement effects taking into consideration the advertisement observers' movement direction.

FIG. 19 is a drawing showing an example of effect analysis results obtained from the process shown in FIG. 18.

FIG. 20 is a drawing for explaining the method of determining differences in advertisement effects based on the advertisement observers' movement direction.

### EXPLANATION OF SYMBOLS

11 display device
21 camera
32 advertisement effect distribution device
41 effect measurement device
100 advertisement display system

### BEST MODE FOR CARRYING OUT THE INVENTION

An advertisement display system 100 according a preferred embodiment of the present invention is described below with reference to the drawings.

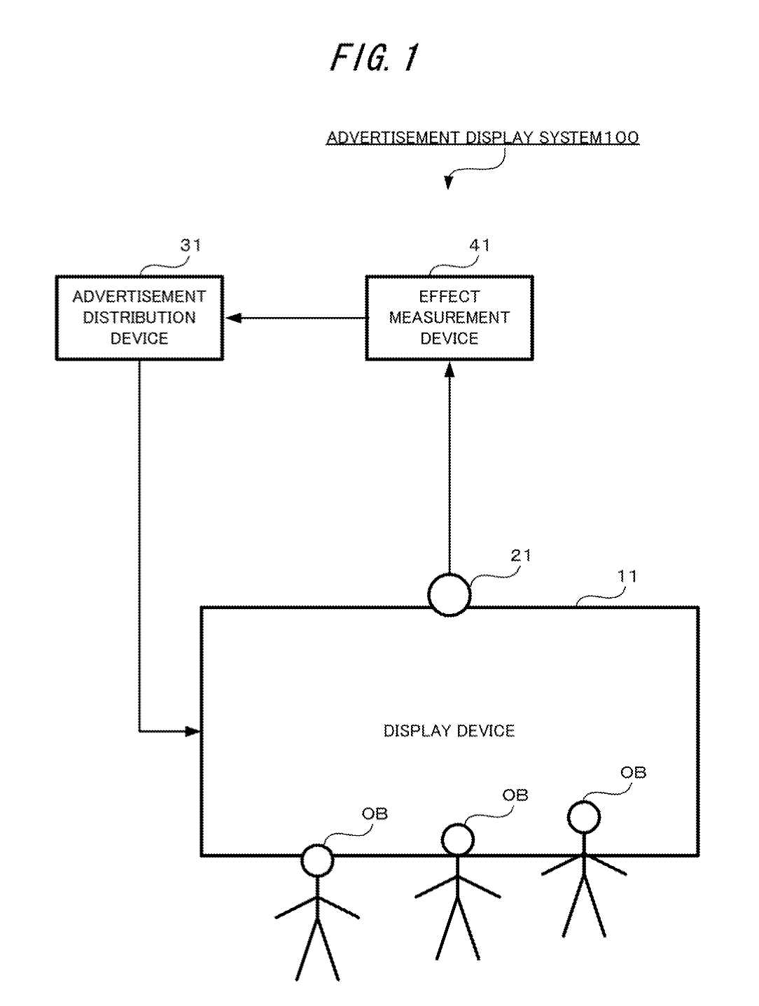

The advertisement display system 100 according to a preferred embodiment of the present invention has a display device 11, a camera 21, an advertisement distribution device 31 and an effect measurement device 41, as shown in FIG. 1.

The display device 11 has, for example, a relatively large display device, such as a plasma display panel, a liquid crystal display panel or the like, and speakers or other audio devices. The display device 11 may be installed on the street, in a vehicle, etc. and displays advertising images and produces audio sound to provide advertising to observers OB.

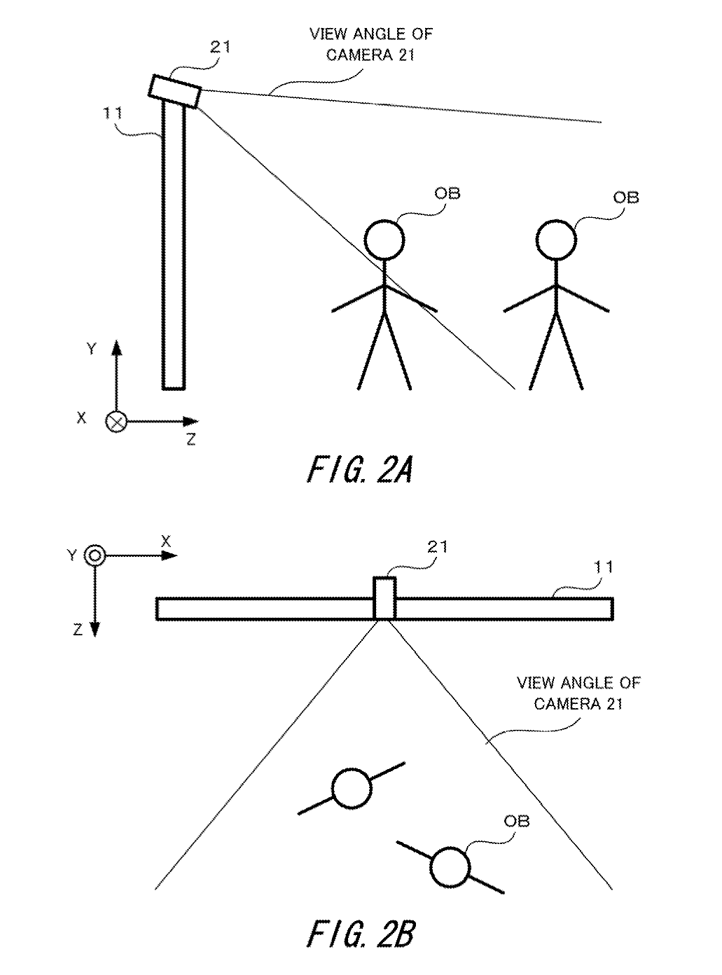

The camera 21 consists of a charge-coupled device (CCD) camera, a CMOS sensor camera or the like positioned near the display device 11, and as shown in FIGS. 2A and 2B, captures images of the front area including near the display device 11, in other words the region where the display on the display device 11 is visible.

The advertisement distribution device 31 is connected to the display device 11 via a network and supplies multimedia data including advertisements to the display device 11 in accordance with a schedule.

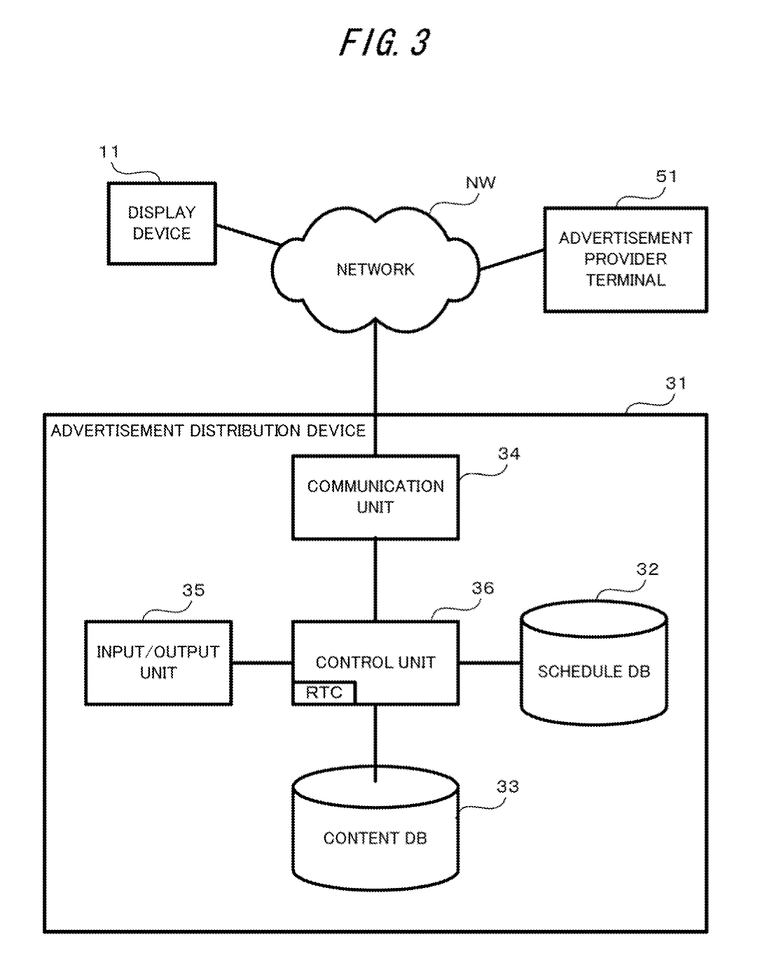

FIG. 3 shows one example of the composition of the advertisement distribution device 31. As shown in this drawing, the advertisement distribution device 31 has a schedule database (DB) 32, a content DB 33, a communication unit 34, an input/output unit 35 and a control unit 36.

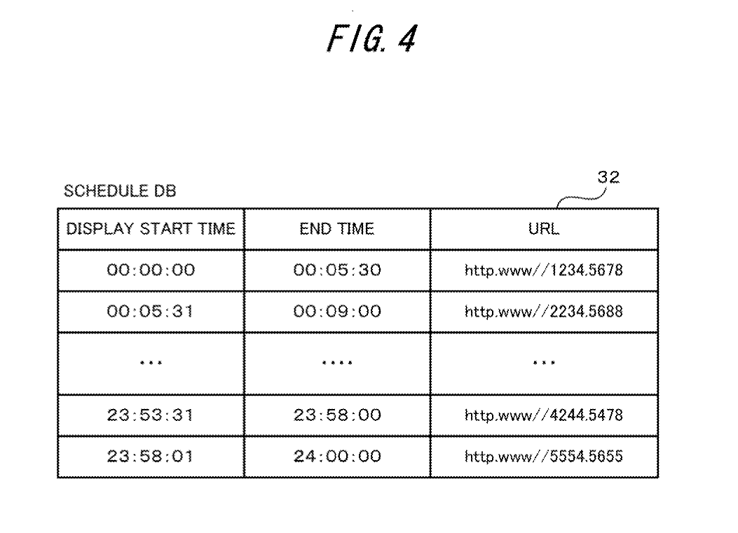

The schedule DB 32 stores a distribution schedule for distributing (displaying) advertisements. Specifically, the schedule DB 32 stores in memory a distribution schedule that correlates advertisement distribution (display) times (display start time and end time) and an address (URL (Uniform Resource Locator)) showing the position where the content (for example; video with sound) to be distributed (displayed) is stored, as shown in FIG. 4.

Returning to FIG. 3, the content DB 33 stores the content (for example, video with audio in MPEG format) to be distributed (displayed). The various content stored in the content DB 33 is specified by URL. The distribution schedule specifies content to be distributed by this URL.

The communication unit 34 communicates with the display device 11, the advertisement provider terminal 51 of the advertisement provider, etc., via a network NW such as the Internet.

The input/output unit 35 is provided with a keyboard, mouse, display device and the like, inputs various commands and data to the control unit 36 and displays output from the control unit 36.

The control unit 36 has a processor or the like and in addition to having a real time clock (RTC) acts in accordance with control programs. Specifically, the control unit reads out content to be displayed on the display device 11 from the content DB 33 following the distribution schedule stored in the schedule DB 32. Furthermore, the control unit 36 supplies read-out content to the display device 11 from the communication unit 34 via the network NW. Furthermore, the control unit 36 receives content from the advertisement provider terminal 51 used by advertisement creators and stores this at URLs designated by the content DB 33. In addition, the control unit 36 edits and updates the distribution schedule in response to commands from the input/output unit 35.

The effect measurement device 41 shown in FIG. 1 analyzes each frame of images captured by the camera 21 to identify people (observers) OB watching the display images on the display device 11. Furthermore, the effect measurement device 41 finds the attributes (such as age level, sex, etc.) of identified observers OB, stopping time (continuous time spent observing the display images) and average distance from the display device 11 (average distance between an observer OB and the display device 11). Furthermore, the effect measurement device 41 finds an index indicating the advertisement effect on each observer OB based on the stopping time and the average distance.

As an index for the degree to which observers paid attention to advertisements, in this embodiment, the advertisement's effect on the observers is indicated by an index of great, medium and small based on the correlation between the stopping time T and the average distance R, as shown in FIG. 5. This index increases as the time attention is given to the display images (viewing time) increases and decreases as the distance from the display device 11 increases.

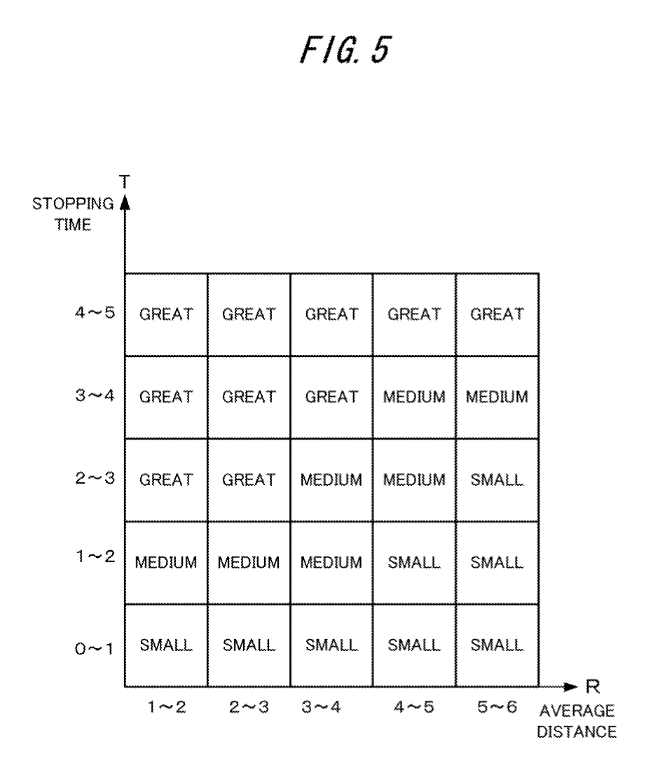

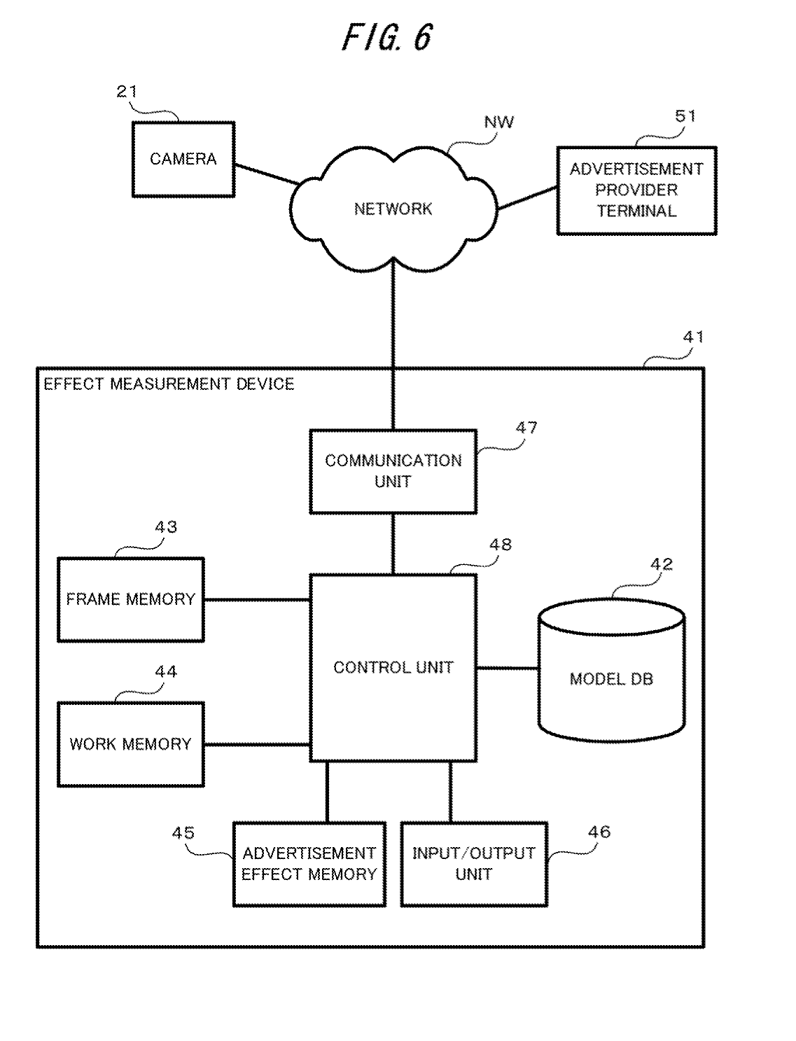

FIG. 6 shows an exemplary composition of the effect measurement device 41.

As shown in this figure, the effect measurement device 41 is connected to the camera 21 via the network NW, and has a model DB 42, a frame memory 43, a work memory 44, an advertisement effect memory 45, an input/output unit 46, a communication unit 47 and a control unit 48.

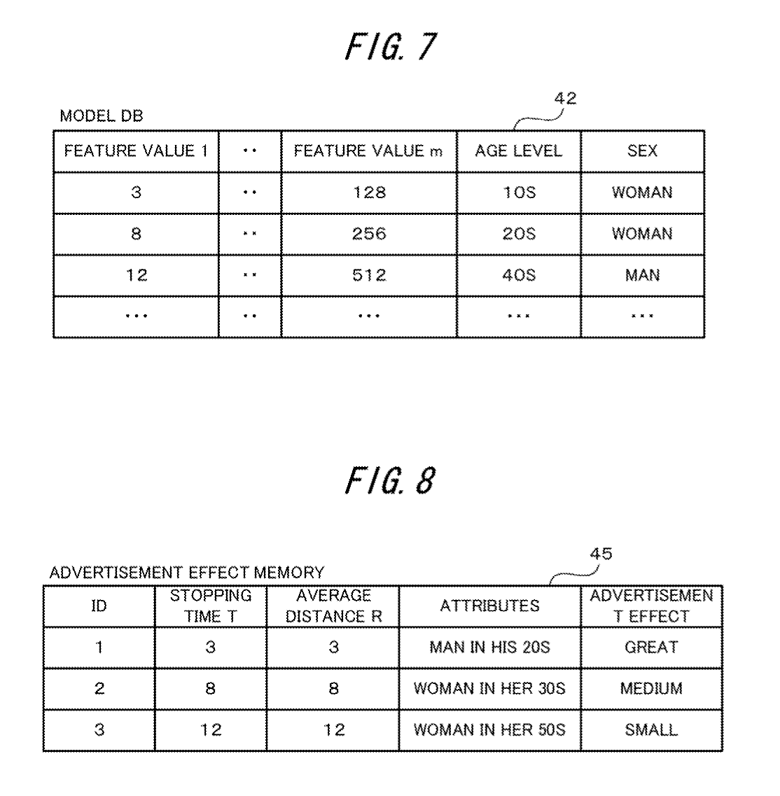

The model DB 42 stores in memory the relationship (model information) among the age level, sex and combination of various feature values obtained through analysis of a model (statistics) of facial images, an example of which is shown in FIG. 7.

The frame memory 43 stores in succession each frame image supplied from the camera 21.

The work memory 44 functions as a work area for the control unit 48.

The advertisement effect memory 45 stores an ID specifying the individual, the stopping time T, the average distance R, attributes (age, sex, etc.) and an index indicating advertisement effect for each individual analyzed as viewing (observing) the advertisement displayed on the display device II, as shown in FIG. 8. The advertisement effect is evaluated in the three gradations of great, medium and small based on the evaluation standards shown in FIG. 5.

Returning to FIG. 6, the input/output unit 46 is provided with a keyboard, mouse, display device and the like, inputs various commands and data to the control unit 48 and displays output from the control unit 48.

The communication unit 47 communicates with the camera 21, the advertisement provider terminal 51 of the advertisement provider, etc., via a network NW such as the Internet.

The control unit 48 has a processor or the like, acts in accordance with control programs, receives images captured by the camera 21 via the communication unit 47 and stores these images in the frame memory 43.

In addition, the control unit reads out frame images stored in the frame memory 43 in succession, conducts image analysis using the work memory 44 and detects the glances of the faces in the images (glances in the direction of the camera 21, that is to say glances toward the images displayed on the display device 11). Furthermore, the control unit 48 finds the various feature values of the faces whose glances were detected and estimates the attributes (age level, sex) of each observer on the basis of the combination of feature values found and model information stored in the model DB 42.

Furthermore, the control unit 48 determines the stopping time T and the average distance R from the display device 11 for observers whose glances were detected.

Furthermore, when glances cannot be detected, the control unit 48 finds the advertisement effect for those observers on the basis of the stopping time T, the average distance R and the evaluation standards shown in FIG. 5 and records this in the advertisement effect memory 45, an example of which is shown in FIG. 8.

Next, the action of the advertisement display system 100 having the above-described composition will be explained.

The control unit 36 of the advertisement distribution device 31 at fixed intervals references the schedule DB 32 and the time on the built-in RTC and finds the URL indicating the storage position of content to be distributed to the display device 11. The control unit 36 reads out the content specified by the found URL from the content DB 33, and sends this content to the display device 11 via the communication unit 34 and the network NW.

The display device 11 receives the content sent and displays this content in accordance with a schedule.

The advertisement provider can change the advertisement displayed without revising the schedule itself by overwriting the content stored in each URL using the advertisement provider terminal 51.

The camera 21 regularly captures images in front of the display device 11, shown in FIGS. 2A and 2B, for example, taking frame images with a frame period of 1/30 of a second, and provides these to the effect measurement device 41 via the network NW.

The control unit 48 of the effect measurement device 41 accepts frame images from the camera 21 via the communication unit 47 and stores these in the frame memory 43.

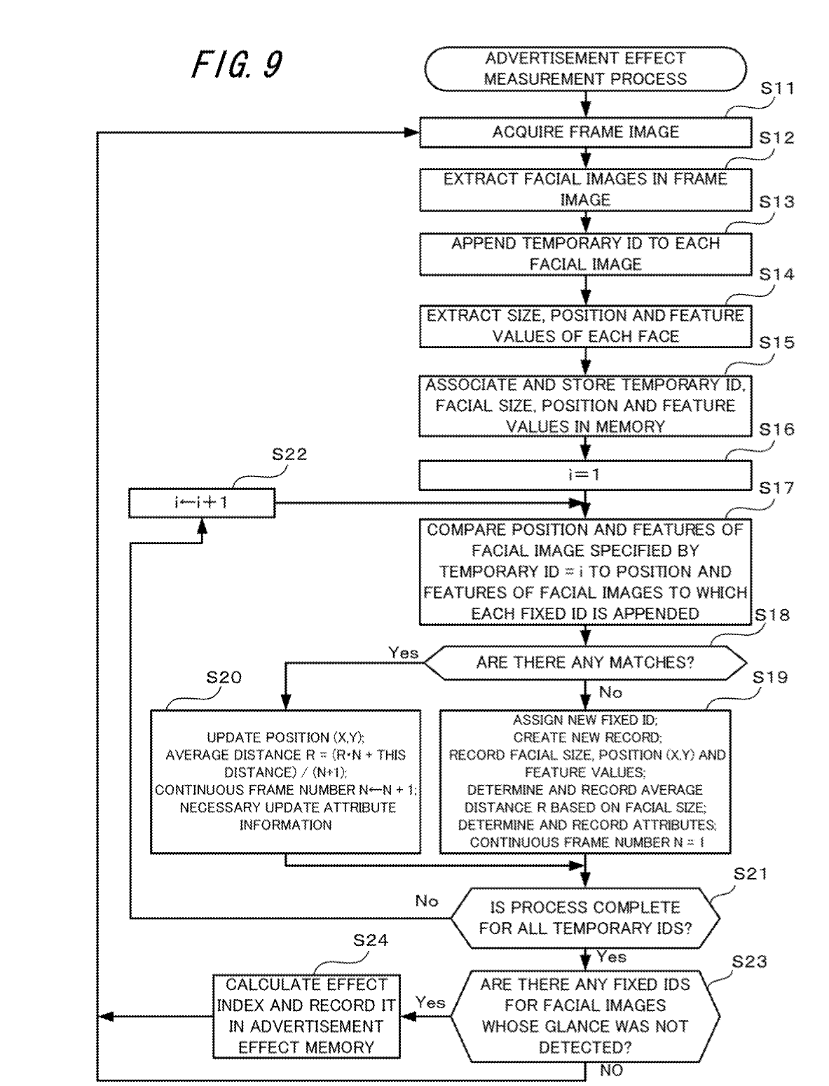

On the other hand, the control unit 48 periodically executes the advertisement effect measurement process shown in FIG. 9 after the power is turned on.

First, the control unit 48 receives one frame image from the frame memory 43 and expands this in the work memory 44 (step S11).

Next, the control unit 48 extracts facial images of people (observers) looking at the display device 11 from within the frame image received (step S12).

The method of extracting facial images of people (observers) looking at the display device 11 is arbitrary. For example, the control unit 48 could, using a threshold value determined based on the average luminosity of the frame image as a whole, binarize the frame image and extract a pair of two black dots (assumed to be images of eyes) within a set distance (corresponding to 10-18 cm) in the binarized image. Next, the control unit 48 could extract the image within a set range in the original frame image using the extracted pair of black dots as the standard, match this with a sample of facial images prepared in advance, and extract this image as the facial image of a person looking at the display device 11 in the case of a match.

Even when facial images can be extracted, it is necessary to engineer the system so as to not extract facial images of people not looking at the screen of the display device 11.

For example, after extracting a facial image, the control unit 48 may determine the orientation of the face from the position of the center of gravity of the face, determine whether the pupils in the images of the eyes are looking in either the right or left direction, determine whether or not the direction of the actual glance is toward the screen of the display device 11 and extract only those facial images determined to be facing the screen.

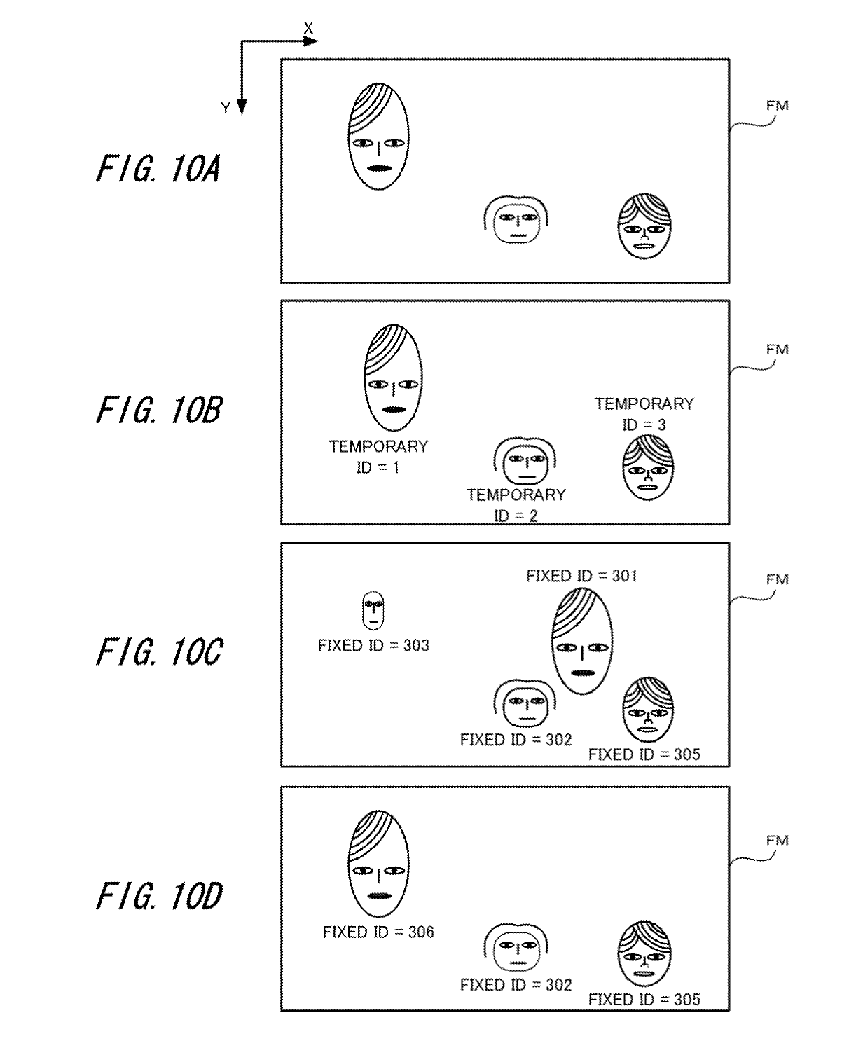

Next, the control unit 48 attaches a temporary ID to each extracted facial image (step S13). For example, if three facial images determined to be looking at the display device 11 are extracted in the frame image FM, as shown in FIG. 10A, temporary IDs (=1, 2 and 3) are attached, an example of which is shown in FIG. 10B.

Next, the control unit 48 finds the size (vertical and horizontal dot number) of each facial image to which a temporary ID is attached and the position (X,Y coordinates) in the frame image FM of each facial image (step S14). Furthermore, the control unit 48 finds various feature values for identifying the face after normalizing the size of each facial image to a standard size as necessary (step S14).

Here, “feature values” are various parameters indicating the features of the facial image. Specifically, parameters indicating any kind of characteristics may be used as feature values, such as a gradient vector showing the density gradient of each pixel of the facial image, color information (hue, color saturation) of each pixel, information showing texture characteristics and depth, and information indicating characteristics of edges contained in the facial image. As these feature values, various commonly known feature values may also be used. For example, it is possible to use the distance between the two eyes and the point of the nose, and the like, as feature values.

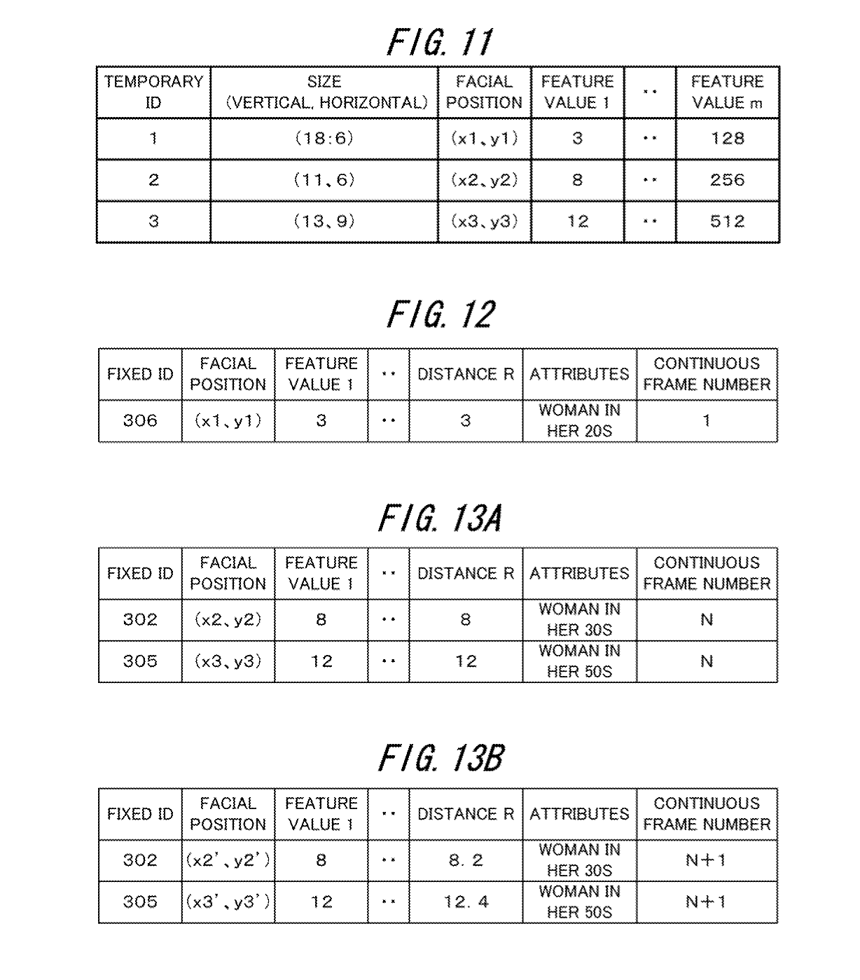

The control unit 48 associates the temporary ID of the facial images found, the facial size, position and feature values and stores these in memory, for example as shown in FIG. 11 (step S15).

Next, the control unit 48 sets a pointer i indicating the temporary ID to an initial value of 1 in order to process the various facial images to which temporary IDs have been attached (step S16).

Next, the control unit compares the position and characteristics of the facial image designated by the temporary ID=i to the position and characteristics of a plurality of facial images extracted up to the prior frame and to which a fixed ID has been attached (step S17) and determines whether or not there are any matches (step S18).

A person cannot move very much during the frame period (for example, 1/30 of a second). For example, when walking at a normal pace, a person can only move around 10 cm. Therefore, if the feature values are almost the same within the movement range of around 10 cm from the prior position, the control unit 48 determines that this is the face of the same person. Conversely, if there are large differences in the feature values even if the positions substantially match, or if there are large variances in position even though the feature values substantially match, the control unit 48 determines that this is the face of a different person.

For example, suppose that the current frame image FM is shown in FIG. 10B and the prior frame image FM is shown in FIG. 10C. In this case, the facial images designated by the temporary IDs=2 and 3 have substantially the same position and feature values as the facial images designated by the fixed IDs=302 and 305, so these are determined to match. On the other hand, the facial image designated by the temporary ID=1 substantially matches the feature values of the facial image designated by the fixed ID=301, but because the positions differ significantly, these are determined to not match. In addition, the facial image designated by the temporary ID=1 and the facial image designated by the fixed ID 303 are in substantially the same position but have feature values that differ significantly, so these are determined to not match.

Returning to FIG. 9, when it is determined in step S18 that a facial image matching one in the prior frame images does not exist (step S18; No), the person in that facial image can be considered a new person who has begun looking at the display on the display device 11. For this reason, the control unit 48 assigns a new fixed ID to that facial image to begin analysis, creates a new record and records the size of the facial image, the position (x,y) in the frame and the feature values (step S19). Furthermore, the control unit 48 determines the average distance R based on the size of the face and records this (step S19). In addition, the control unit 48 compares the set of feature values found with the sets of feature values stored in the model DB 42, finds the age level and sex corresponding to the facial image and records this as an attribute (step S19). Furthermore, the control unit 48 sets the continuous frame number N to 1 (step S19).

In the example shown in FIG. 10, of the three faces shown in FIG. 10B, the face designated by the temporary ID=1 is determined to be a face for which a new glance has been detected in this frame, so a new record is created, as shown in the example in FIG. 12.

Returning to FIG. 9, when the determination in step S18 is that a facial image exists that matches one in the prior frame image (step S18; Yes), the person of that facial image can be considered a person who has continued to look at the display on the display device 11 during that frame interval. To continue analysis of that person, the control unit updates the position (x,y) within the frame screen and updates the average distance R to the value found from the following equation in the corresponding record (step S20).

Average Distance R=(average distance R recorded in corresponding record continuous frame number N+distance found from size of current facial image)/(N+1)

Next, the control unit 48 increments the continuous frame number N by +1 (step S20). In addition, the control unit 48 may also update the attribute information (age level, sex, etc.) as necessary.

In the example shown in FIG. 10, the records corresponding to the facial images with fixed IDs=302 and 305 are updated as shown in FIGS. 13A and 138.

Next, the control unit 48 determines whether or not processing has been completed for all temporary IDs (step S21), and if processing has not been completed (step S21; No), the pointer i is incremented by +1 (step S22) and the control unit returns to step S17 and repeats the same process for the next facial image.

Thus, when processing has been completed for all facial images, in other words when the analysis process has been completed for all people in the currently processed frame image FM determined to be looking at the display on the display device 11, the determination in step S21 is Yes.

When the determination in step S21 is Yes, the control unit 48 determines whether or not there are any fixed IDs for facial images whose facial image (glance) was not detected (step S23).

In other words, when a glance was detected in the prior frame image but is not detected in the current frame, the person corresponding to the facial image was looking at the display on the display device 11 until immediately prior but has stopped looking. Hence, when the determination in step S23 is Yes, the control unit 48 determines advertisement effect for the facial image of the fixed ID that has been determined (step S24). In other words, the control unit 48 finds the stopping time (time spent continuously looking at the display) by multiplying the frame interval ΔT by the continuous frame number N stored in the recorded designated by that fixed ID. In addition, the control unit 48 finds the advertisement effect by applying that stopping time T and the average distance R to the map shown in FIG. 5. Next, the control unit 48 adds this advertisement effect to the record and moves that record from the work memory 44 to the advertisement effect memory 45.

In the example in FIG. 10, the facial image designated by the fixed ID 301 that was in the prior frame image FM shown in FIG. 10C does not exist in the current frame image shown in FIG. 10D. Consequently, the advertisement effect is found for the facial image designated by the fixed ID 301, and a new record is added to the advertisement effect memory 45 shown in FIG. 8.

Following this, the flow returns to step S11.

On the other hand, when the determination in step S23 is No, the control unit 48 skips step S24 and returns to step S11.

By repeating this kind of process, fixed IDs are attached to people (facial images) determined to be newly looking at the display on the display device 1, and the distance R and the like is continuously analyzed across multiple frames based on this fixed ID. Furthermore, at the stage when it is determined that a person has stopped looking at the display on the display image II, analysis of the facial image of that fixed ID is concluded and the advertisement effect and attributes, etc., are found.

Furthermore, the control unit 48 appropriately analyzes the information stored in the advertisement effect memory 45 and supplies this to the advertisement provider terminal 51 and the like.

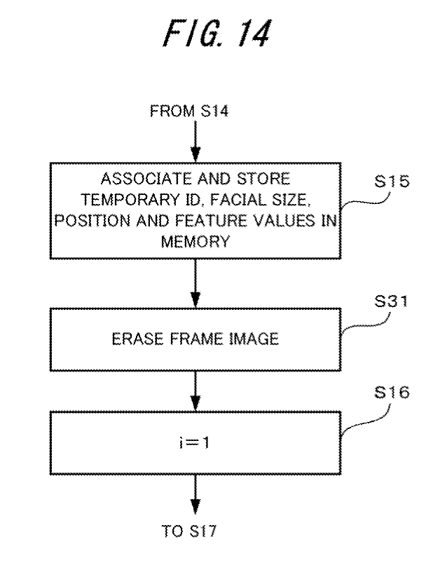

As shown in FIG. 14, the process in step S31 may be added to completely erase by resetting the frame images recorded in the frame memory 43 immediately after the temporary ID, facial size, position and feature values are made to corresponded in step S15. By doing this, it is possible to prevent facial images from leaking to the outside. In this case, the subsequent processes may be performed only on data appended to the obtained temporary ID.

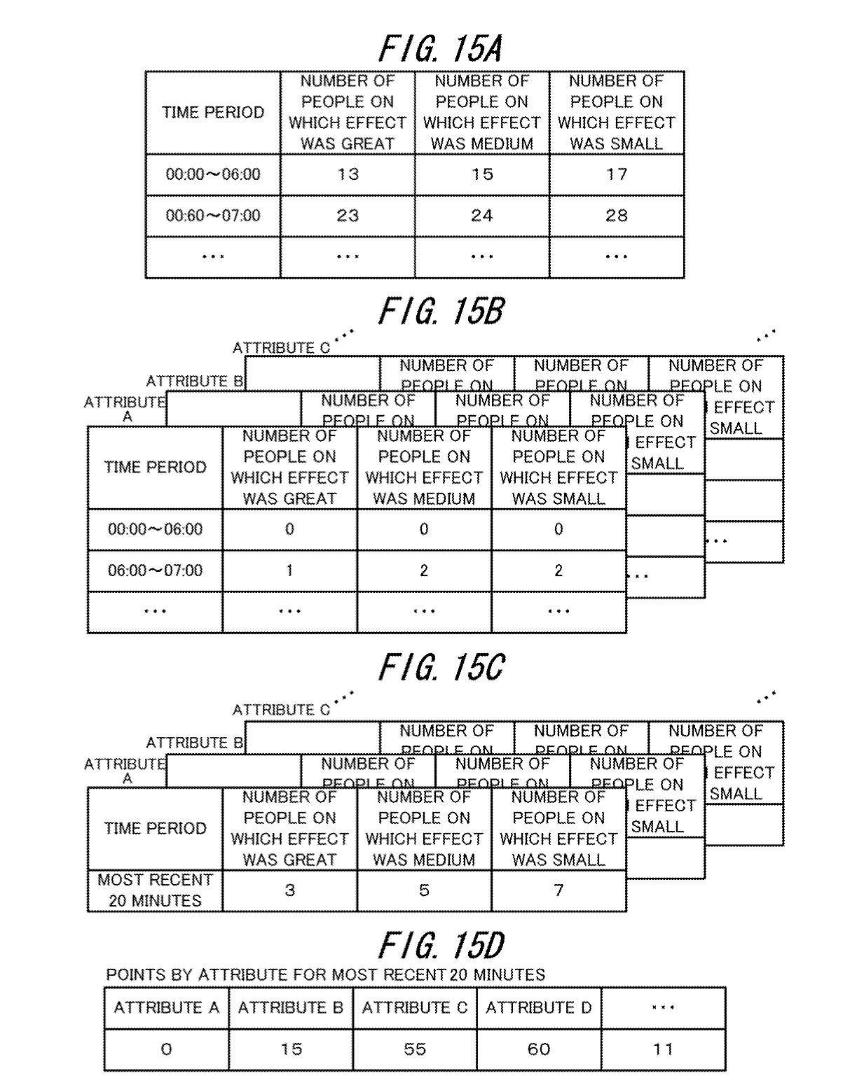

In addition, the control unit 48 may accomplish a more detailed analysis, the advertisement effect may be measured by sorting by each time period (FIG. 15A), each attribute (FIG. 15B), each combination of time period and attribute (FIG. 15C), and by attribute within a set time from the present (FIG. 15D), and controlling (selecting) advertisements distributed based on that measurement result. The point sought by attribute in FIG. 15D is, for example, to find points corresponding to great, medium and small advertisement effects as totaled by attribute.

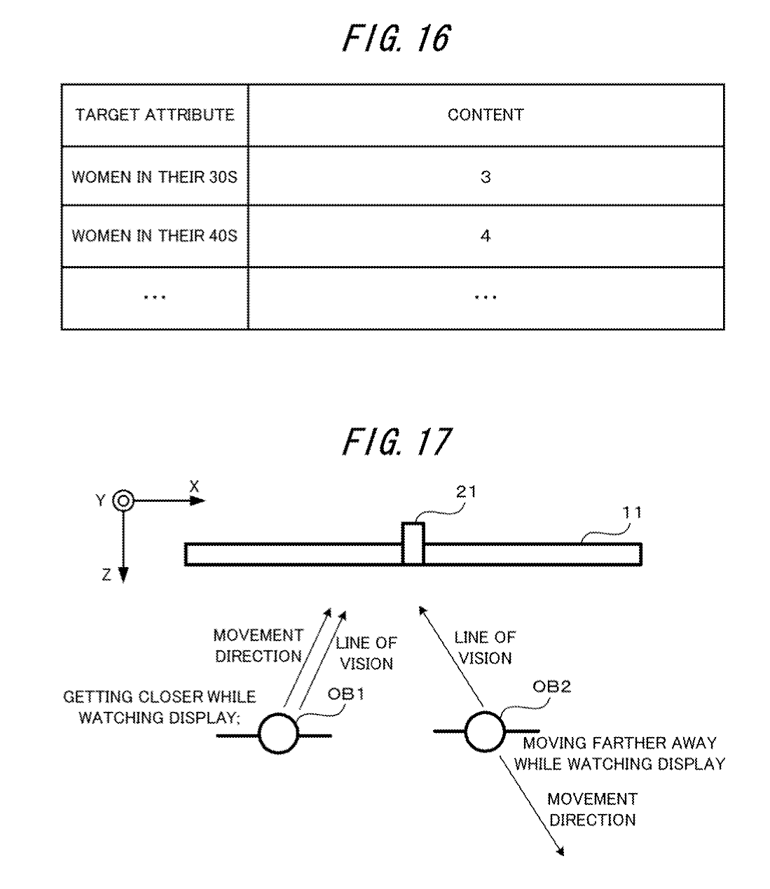

In addition, as shown in FIG. 16, distribution and display may also be made by determining advertisements targeting attributes in a specific range with high advertisement effect based on the advertisement effects found by attribute recently, by appending targeted attributes (age level and sex) to content to be displayed (distributed).

The method of analyzing the advertisement effect is arbitrary.

For example, in the present embodiment, the advertisement effect is analyzed in three gradations of great, medium and small on the basis of the five gradations of average distance R and the five gradations of stopping time T, but the number of gradations of distance, the number of gradations of stopping time and furthermore the number of gradations of advertisement effect can be arbitrarily set. Furthermore, analysis of advertisement effect in three gradations and analysis of advertisement effect in seven gradations may be performed concurrently. In addition, analysis results of advertisement effect may be sent in response to requests from the analysis requestor, such as in three gradations to client A and in seven gradations to client B.

Furthermore, the analysis of advertisement effect shown in FIG. 5 may be accomplished by attribute.

In addition, it is possible to use an index for advertisement effect illustrated by the following equation, for example, rather than the stepwise index shown in FIG. 5.

Advertisement effect=Σk/Ri

Here, k is an arbitrary constant and Ri (i=1, 2, . . . ) is the distance from the display device 11 of each person whose glance was detected.

Furthermore, the analysis period (time period) may be shorter intervals or longer intervals, and can be the frame units of the displayed advertisement images.

For example, a clock to which the display device 11 and the camera 21 are synchronized is supplied to synchronize the display frames of the display device 11 and the frames captured by the camera 21. Furthermore, the images of each capture frame of the camera 21 may be analyzed and the number of people looking at the display device and their attributes may be found as the advertisement effect of the corresponding display frame with this timing and output.

In addition, the unit time of analysis, the standards for evaluation and so forth may be set or added to through settings from external devices via the input/output unit 46 and the communications unit 47. For example, when the correlation between attributes and the combination of feature values obtained by analyzing facial images are newly determined, that correlation may be provided to the control unit 48 from outside devices via the input/output unit 46 or the communication unit 47, and the control unit 48 can make that the target of analysis.

In addition, in general it is understood that the advertisement effect is relatively high on people who came closer to the display device 11 while viewing the display on the display device 11 and the advertisement effect is relatively low on people who moved away from the display device 11 while viewing the display on the display device 11. For example, in the example in FIG. 17, assuming the stopping time is the same, the advertisement effect is relatively high on a person OB1 who approached the display device 11 while viewing the display, and the advertisement effect is relatively low on a person OB2 who moved away from the display device 11 while viewing the display.

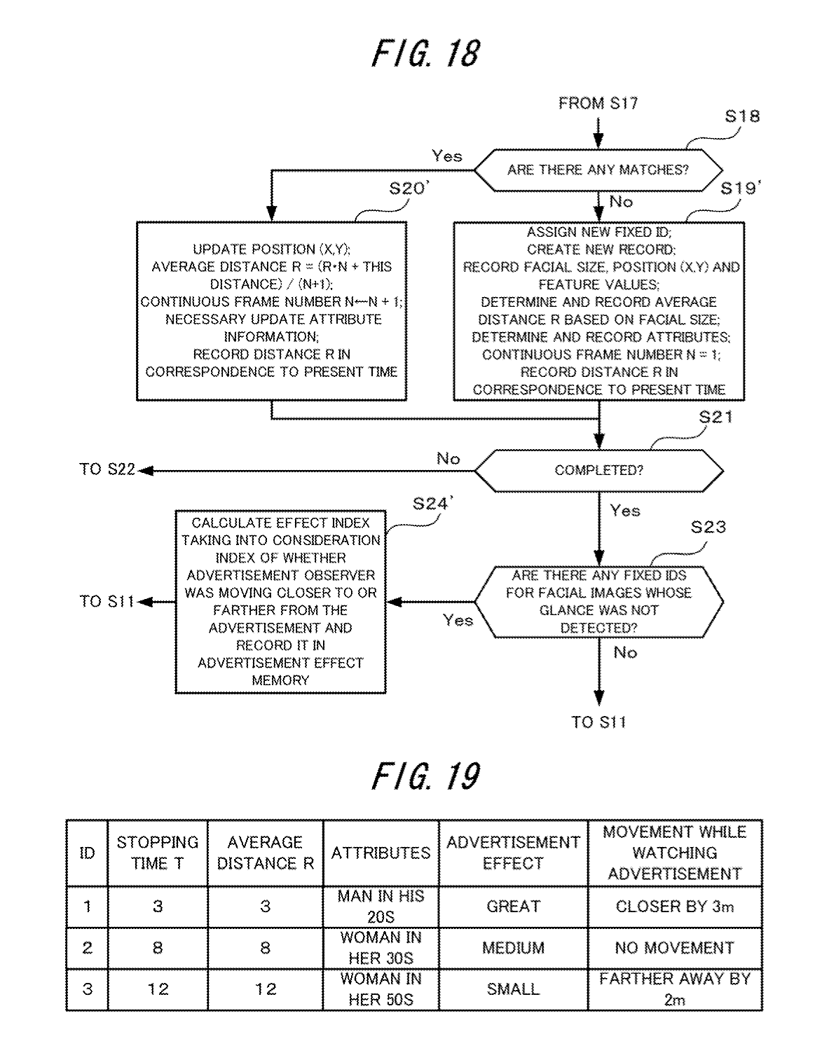

For example, it would be fine to implement an advertisement effect measurement process with steps S19, S20 and S24 in FIG. 9 replaced by steps S19′, S20′ and S24′ shown in FIG. 18. In other words, in steps S19′ and S20′, the control unit 48 records the distance R between the observer OB and the display device 11 corresponding to the present time, in addition to the conventional analysis process.

In addition, in step S24′, the control unit 48 analyzes the history of the distance R on the time axis, determines an index showing whether the advertisement observer is moving toward or away from the advertisement and finds the advertisement effect taking this index into consideration as well. For example, when the history shows the distance R becoming smaller by more than a standard amount, such as 4→3.9→3.8→ . . . →2, the control unit 48 may increase the advertisement effect by +m gradations (where m is a numeral showing the extent of approach), and when the history shows the distance R becoming smaller by more than a standard amount, such as 3→3.1 →3.2→ . . . →5, the control unit 48 may decrease the advertisement effect by −n gradations (where n is a numeral showing the extent of moving away), so that the advertisement effect is easily influenced by the movement direction and/or the amount of movement. In addition, as shown in FIG. 19, it would be fine to provide an index indicating approaching or moving away from the advertisement as a separate index from the above-described advertisement effect.

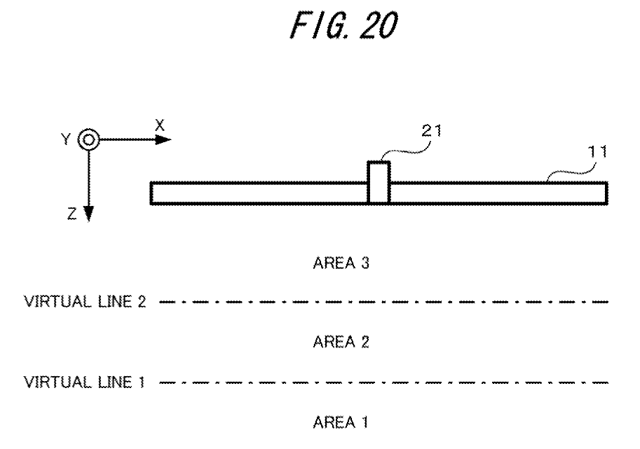

In addition, it would also be fine to establish virtual lines (virtual lines 1, 2) partitioning the area in front of the display device 11 into a plurality of areas (areas 1, 2, 3), for example as shown in FIG. 20, and to apply additional advertisement effect points when a virtual line is crossed from the history of the change in distance, such as increasing the index indicating advertisement effect (points) by +m when the observer OB moved from area 1 across the virtual line 1 to the closer area 2, and furthermore for the points to be increased by +n when the observer OB moved from area 2 across the virtual line 2 to the closer area 3. In addition, it would be fine to decrease the points by +m when the observer OB moved from the area 3 across the virtual line 2 to the more distance area 2, and to decrease the points by −n when the observer OB moved from the area 2 across the virtual line 1 to the more distance area 1.

The above explanation has centered on advertisement distribution and display, but the present invention is not limited to advertising and may be applied to arbitrary content, for example teaching materials displays, public information displays and the like.

In addition, the system compositions shown in FIG. 1, FIG. 3 and FIG. 6, and the flowcharts shown in FIG. 9 and FIG. 18 are examples, and appropriate variations are possible so long as the same functions can be realized.

For example, the display device 11 may be a projection device. In this case, the camera 21 may be positioned on the screen (for example, a building wall screen or the like).

In addition, it would also be fine to arrange a plurality of cameras 21 and from the stereo images find the distance to the observer OB.

This application claims the benefit of Japanese Patent Application 2008-016938, filed Jan. 28, 2008, the entire disclosure of which is incorporated by reference herein.

### INDUSTRIAL APPLICABILITY

The present invention can be used as an electronic signboard displaying advertisements.

1. A display system, comprising:
a display device for displaying images;
an imaging unit for taking images in a region where display images on the display device can be observed; and
an image analysis unit for analyzing images taken by the imaging unit, discriminating observers looking at the display images on the display device, and determines the time each discriminated observer pays attention to the display images on the display device and each observer's distance from the display device.

2. The display system according to claim 1, further comprising:
an index creation unit that finds an index indicating the degree of attention paid to the display on the display device in accordance with predetermined standards on the basis of the attention time and distance determined by the image analysis unit.

3. The display system according to claim 1, wherein:
the image analysis unit further comprises a unit for analyzing images taken by the imaging unit and determining the attributes of each observer.

4. The display system according to claim 3, further comprising:
an index creation unit that finds an index indicating the degree of attention for each attribute paid to the display on the display device in accordance with predetermined standards on the basis of the attention time, distance and attributes of each observer discriminated by the image analysis unit.

5. The display system according to claim 4, wherein attributes of targeted people are appended to each display image displayed on the display device, and
further comprising a unit for determining display images to display on the display device on the basis of an index indicating the degree of attention found for each attribute by the index creation unit.

6. The display system according to claim 2, wherein:
the index creation unit makes the index value larger as the time spent paying attention to the display image becomes longer and makes the index value smaller as the distance becomes greater.

7. The display system according to claim 2, wherein:
the image analysis unit further comprises a unit for finding the movement direction when an observer is moving while paying attention to the display; and
the index creation unit creates index values on the basis of changes in the movement direction.

8. The display system according to claim 2, wherein:
the image analysis unit further comprises a unit for finding the movement distance when an observer is moving while paying attention to the display; and
the index creation unit creates index values on the basis of changes in the movement distance.

9. The display system according to claim 2, wherein:
the image analysis unit further comprises a unit for finding changes in areas to which an observer belongs due to movement direction when this observer is moving while paying attention to the display; and
the index creation unit creates index values on the basis of this change in areas.

10. The display system according to claim 1, further comprising:
a distribution unit for distributing display images to the display device; wherein
the distribution unit comprises a unit for selecting display images to be distributed on the basis of an index created from the determination results of the image analysis unit.

11. The display system according to claim 1, further comprising:
a distribution unit for distributing display images to the display device; wherein
the distribution unit comprises a unit for selecting display images to be distributed on the basis of an index created by the index creation unit or created from the determination results of the image analysis unit.

12. A display effect measurement system, comprising:
a discrimination unit for analyzing images taken around a display device and discriminating people paying attention to display images; and
an image analysis unit for determining the distance from the display device and the time spent paying attention to display images on the display device by each person discriminated by the discrimination unit.

13. A display method for:
displaying display images;
capturing images in an area where the display images are visible; and
analyzing the captured images and determining the distance from the display images and the time spent paying attention to the display images for people paying attention to the display images.

14. A display effect measurement method for:
analyzing images captured in an area where display images are visible and specifying people paying attention to the display images; and
determining distance from the display images and time spent paying attention to the display images for each specified individual.

15. A recording medium readable by computer, on which is recorded a program that functions as:
a discrimination unit for analyzing images in an area where display images on a display device can be observed, and discriminating observers looking at said display images; and
an image analyzing unit for determining distance from the display device and time spent paying attention to display images on the display device for each observer discriminated by the discrimination unit.
